(19) United States
(12) Patent Application Publication
(10) Pub. No.: US 2008/0093384 A1
(43) Pub. Date: Apr. 24, 2008

(54) SELF-CONTAINED BEVERAGE DISPENSER

(76) Inventors: David J. Fire, Lawrenceville, GA (US); William S. Credle, Roswell, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/875,109

(22) Filed: Oct. 19, 2007

Related U.S. Application Data
(60) Provisional application No. 60/853,175, filed on Oct. 20, 2006.

(51) Int. Cl. B67D 5/06; B65D 83/00; B67D 3/00

(52) U.S. Cl. 222/144.5; 222/146.6; 222/530; 222/538; 222/399

(57) ABSTRACT

A portable beverage dispenser includes a portable ice chest, a dispensing valve device, a pressurization system, and a line system. The line system couples one or more beverage containers in the ice chest to the pressurization system through one or more gas lines, and couples the beverage containers to the dispensing valve device through one or more beverage lines. Actuating the dispensing valve device opens a valve and allows the beverage to flow into a cup under force of the pressurization system. A retractor, such as a spring-loaded reel, can also be included to facilitate keeping the dispensing valve device close to the ice chest when not in use.

### CROSS-REFERENCE TO RELATED APPLICATION

The benefit of U.S. Provisional Patent Application Ser. No. 60/853,175, filed Oct. 20, 2006, is hereby claimed, and its specification is hereby incorporated herein in its entirety.

### BACKGROUND OF THE INVENTION

1. Field of the Invention

The present invention relates to an economical, portable, self-contained beverage dispenser.

2. Description of the Related Art

Beverages such as carbonated soft drinks are often served at picnics, festivals, shows and other catered events. At such events, such beverages are commonly dispensed using what is known in the art as a “premix” system. In a premix system, a carbonated soft drink is dispensed from a package containing a manufacturer-blended mix of soft drink syrup and carbonated water. In the United States, a five gallon stainless steel tank is the time-honored package provided by most major soft drink bottling companies. The packaged product is dispensed under pressure provided by a carbon dioxide gas tank and is identical to the bottling company's bottled or canned version of the product. In contrast, a “postmix” system makes the soft drink on location. That is, the manufacturer or bottling company provides a package of beverage syrup, which a postmix machine or dispenser blends with water and carbon dioxide gas at the dispensing valve as it dispenses the product.

Premix and postmix systems used in bars can include a multi-product (multi-flavor) dispenser “gun” or nozzle that receives beverage lines from multiple tanks or packages and has multiple buttons corresponding to the products. A bartender can press any desired button to dispense the corresponding product. The WUNDER-BAR line of multi-product dispenser guns produced by Automatic Bar Controls, Inc. of Vacaville, Calif. is a well-known example of such products.

Commercially available premix and postmix beverage systems are problematic when they are used in low-volume situations, such as small picnics and events. Conventional postmix systems are too expensive, too large and too complicated to be practical for low-volume remote locations. Most have complicated carbonation systems that must be connected to a city water supply. Also, the syrup packages available for these systems are too large to be practical for a low-volume event. Conventional premix systems are also too expensive and too large for low-volume remote locations. They are not as complicated as postmix systems, but they are difficult to sanitize and keep clean, and the beverage containers used with these systems are too large to be convenient for low-volume events. Conventional premix dispensers are also prone to delivering drinks with excessive foam.

An alternative to dispensing beverages from a dispenser is to manually pour beverages from common consumer-oriented containers such as single-serving 12-oz cans or bottles or the larger 2-liter plastic bottles. However, these packages are prone to delivering flat drinks if the entire contents are not consumed immediately after opening. It is also time consuming to open and pour beverages from these containers. Often times, at a busy remote bar location, time is of the essence.

### SUMMARY OF THE INVENTION

The present invention relates to a portable beverage dispenser comprising an insulated portable ice chest. In an exemplary embodiment of the invention, the beverage dispenser further comprises a dispensing valve device, a pressurization system, and a line system. The pressurization system has one or more portions, such as a gas (e.g., CO₂) cylinder, regulator, etc., disposed inside the ice chest that can be coupled to one or more beverage containers, such as standard 2-liter soft drink bottles, inside the ice chest. The line system couples the containers to the pressurization system through one or more gas lines, and couples the beverage containers to the dispensing valve device through one or more beverage lines. The beverage lines extend outside the ice chest and allow the user to manipulate the dispensing valve device over a cup (or drinking glass, pitcher, etc.). The dispensing valve device has buttons or other means for manually operating its one or more valves. Pressing a button, for example, causes the device to open a valve and allow the beverage to flow into the cup under force of the pressurization system. A retractor, such as a spring-loaded reel, can also be included to facilitate keeping the dispensing valve device close to the ice chest when not in use.

The dispensing valve device can be of a multi-beverage (multi-flavor) type, having a plurality of manually operable buttons and a corresponding plurality of valves, with each button coupled to a corresponding valve to dispense a corresponding beverage.

The dispenser is economical enough to be practical for use at remote, low-volume events, such as picnics and festivals. This makes it possible to speed up drink dispensing for events that conventionally could only be efficiently serviced by pouring from premix containers.

### BRIEF DESCRIPTION OF THE DRAWINGS

FIG. 1 is a perspective view of a dispenser with the lid in a closed position, in accordance with an exemplary embodiment of the invention.

FIG. 2 is a perspective view of the dispenser of FIG. 1 with the lid in an open position and portions of the walls cut away to show the internal elements.

FIG. 3 is perspective view of the bottle retaining cage of the dispenser of FIG. 1.

FIG. 4 is a perspective view of the lid assembly of the dispenser of FIG. 1, with the lid cover plate removed and with the bar valve shown in the retracted position.

FIG. 5 is a perspective view, similar to FIG. 4, with the bar valve shown in the extended position.

FIG. 6 is a perspective view of the dispenser of FIG. 1 in combination with a remote bar valve holder.

FIG. 7 is a top plan view of an exemplary bar valve body of the dispenser of FIG. 1.

FIG. 8 is a cross-sectional view of the bar valve of the dispenser of FIG. 1.

### DETAILED DESCRIPTION OF AN EXEMPLARY EMBODIMENT

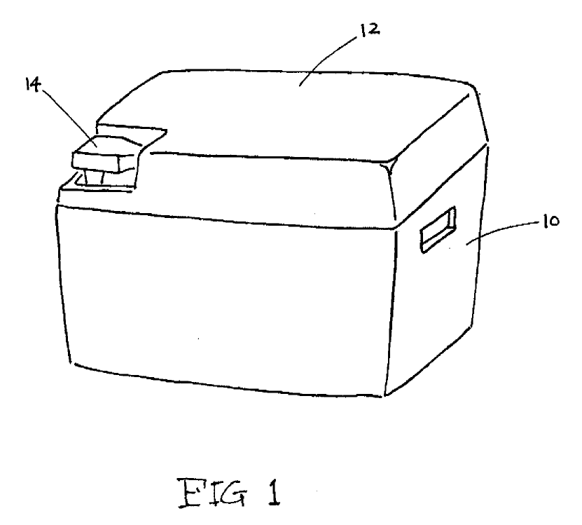

As shown in FIG. 1, in an exemplary embodiment, the dispenser comprises a self-contained beverage dispensing system housed within an insulated chest 10. Except for the novel features described below, the chest 10 is similar to ice chests such as those manufactured by Igloo Products, Inc. under the IGLOO brand and Newell Rubbermaid Inc. under the RUBBERMAID brand. In the United States and some other countries, such an ice chest is are also commonly referred as a “cooler” or “picnic cooler,” though in other countries they are known by other colloquial names, such as “cool box” in the United Kingdom, “esky” in Australia, “chilly bin” in New Zealand, etc. Essentially all such commercially available ice chests are characterized by being small enough to be portable by one person and having a hinged lid and plastic (e.g., polyethylene) or metal double-walled construction, with insulation (e.g., polyurethane foam) inside the walls. Soft-sided coolers made of polyvinyl chloride (PVC), nylon or similar flexible sheet-like materials are also known. As used in this patent specification (“herein”), the term “ice chest” or “cooler” is intended to refer to such an article.

In the exemplary embodiment of the invention, the hinged lid 12 of chest 10 is similar to lids found on commercially available ice chests. Unlike a conventional ice chest lid, lid 12 has a notched-out or recessed area in one corner where a multi-flavor bar valve 14 is stored in preparation for use. (However, in accordance with one aspect of the invention, a conventional ice chest or its lid can be retrofitted or equipped to include such features.) Although the valve 14 is disposed in a recess in one corner of the lid 12 in the exemplary embodiment, in other embodiments of the invention, a valve can be disposed in any other suitable position on the chest and mounted in any other suitable manner. Indeed, in some embodiments it can be completely enclosed within the chest so that the lid would have to be removed or opened to gain access to the bar valve. Also, in other embodiments, the recess or other area where the valve is stored could include a removable drip tray (not shown) to catch any drippings from the bar valve. Alternatively, a fixed drip tray could be included that drains into a receptacle (not shown) inside the ice chest.

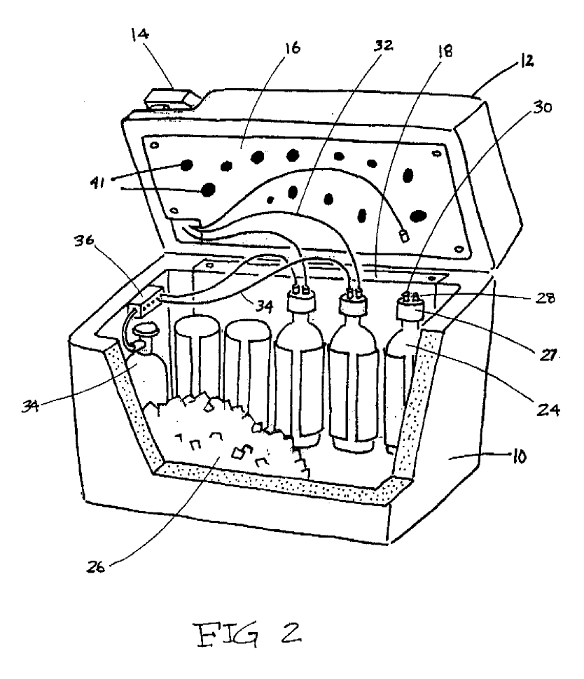

As shown in FIG. 2, attached inside the lid 12 is a cover plate 16, the function of which is described below. The housing of the dispenser can be made of any suitable material and have any suitable structure, such as the double-walled insulated plastic, metal, etc., structure described above with regard to conventional ice chests. Also, although the lid 12 is hinged in the exemplary embodiment of the invention, in other embodiments it can be completely removable, have a sliding door, etc., to allow access to the interior of chest 10. In addition, in other embodiments the ice chest could be equipped with wheels, retractable handle(s) or fold-up legs (not shown).

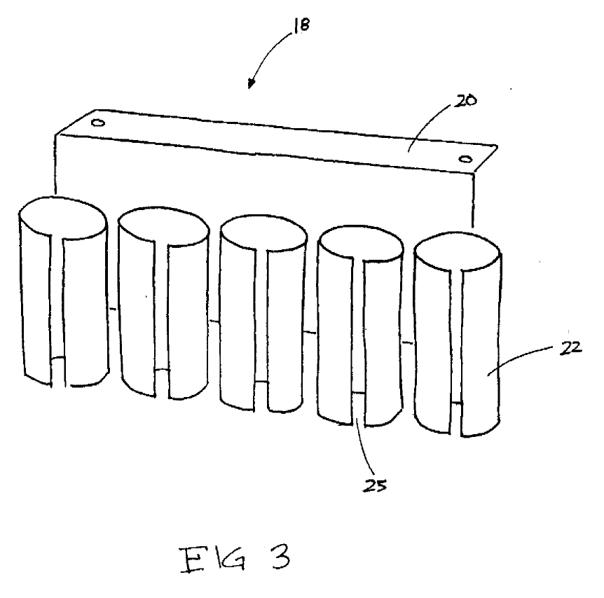

As shown in FIGS. 2-3, included inside chest 10 is a bottle retaining cage 18 which has a mounting flange 20 and flexible bottle gripping cylinders 22 that are capable of retaining 2-liter plastic soft drink bottles 24. The purpose of the retaining cage 18 is to hold bottles 24 in place and to aid in cooling them. In use, cubed or crushed ice 26 is placed in chest 10, as in a conventional ice chest. The cylinders 22 are preferably made of a non-corrosive heat-conductive metal such as aluminum, although other suitable materials can be used. The inside diameters of the cylinders 22 are slightly smaller than the outsides of the bottles 24 to facilitate frictional or resilient engagement of the bottles 24. To provide such engagement, the cylinders 22 have a gap 25 and are made of a material that is thin enough and resilient enough so that the cylinder 22 can flex and expand open when a bottle 24 is pushed into the interior of the cylinder. When a bottle 24 is pushed down inside the cylinder, the cylinder 22 expands slightly and grips the bottle 24 so that the bottle 24 is retained within the cylinder 22. This prevents bottles 24 from floating upward if there is an excess of water created as the ice 26 melts. The tight fit between the cylinder 22 and the bottle 24 also helps the cylinder 22 to conduct heat away from the bottle 24 through the effect of the ice 26, even if the ice 26 is not filled all the way to the top off the cylinder 22. Another function of the cylinder 22 is to prevent ice 26 from entering the inside of the cylinder 22. The presence of the cylinders 22 makes it possible to fill the chest 10 with ice 26 to the top of cylinders 22, and still remove and replace bottles 24 within the cylinders 22 without ice 26 getting in the way. To accomplish this, gap 25, which allows the cylinder 22 to expand, can be smaller than the size of the ice cubes that are used to cool the bottles. The cylinders 22 are spaced above the bottom of the interior of the chest 10 such that the space between the bottoms of the cylinders 22 and the bottom of chest 10 is too small for ice to enter the cylinders 22 from the bottom. However the space is large enough to allow cold ice-melt water to enter the cylinders 22 and help cool the bottles 24.

The bottle retaining cage 18 is designed so that it can easily be removed from the ice chest 10 for cleaning purposes. It is also be easy to remove the bottle retaining cage 18 and replace it with a different retaining cage (not shown) adapted to receive bottles or other containers of other shapes or sizes. It should be noted that although in the exemplary embodiment of the invention the cylinders 22 of the bottle retaining cage 18 are arranged in a straight line, in other embodiments they could be arranged in any other suitable configuration. Likewise, although five cylinders 22 are shown for purposes of illustration, bottle retaining cage 18 can have any suitable number of cylinders 22 or other retainers.

As shown in FIG. 2, a cap assembly 27 is affixed to the top of each bottle 24. The cap assembly 27 is internally threaded to mate with the top of a (standard 2-liter soft drink) bottle 24. To install cap assembly 25, one unscrews the cap from a full bottle 24 and replaces it with the cap assembly 25. In other embodiments, however, a suitable cap assembly could be attached to the bottle or other container by means other than screwing, such as clamping. Included in the cap assembly 27 are two quick-disconnect fittings 28 and 30. Quick-disconnect fitting 28 is a product fitting and includes a diptube (not separately shown) that reaches to the bottom of the bottle 24 and allows the product within the bottle 24 to exit the bottle 24. The second quick-disconnect fitting 30 is a gas fitting, which allows a pressurized beverage gas such as carbon dioxide (CO₂) or nitrogen, to enter the bottle 24 so as to force the product out of the bottle 24 through the diptube of quick-disconnect fitting 28. After a cap assembly 27 is attached to a bottle 24, the bottle 24 is inserted into a cylinder 22. Then two hoses or lines 32 and 34 are connected to the cap assembly 27. The first line 32 is the product line, which includes a quick-disconnect fitting that mates with quick-disconnect fitting 28. Product thus exits the bottle 24 through this line 32. The second line 34 is the gas line, which includes a quick disconnect fitting that mates with quick-disconnect fitting 30. Pressurized gas thus enters the bottle 24 through this line 34. The quick-disconnect feature of the cap assembly 27 allows bottles 24 with cap assemblies 27 in place to be conveniently inserted into retaining cage 18 before lines 32 and 34 are connected to the cap assembly 27. Conversely lines 32 and 34 can quickly and easily be disconnected from the cap assembly 27 before the bottle 24 is removed from the dispenser.

In the exemplary embodiment of the invention, the dispenser can accommodate multiple bottles 24, each with a different beverage (flavor), connected to multiple corresponding product lines. Product lines 32 connect cap assemblies 26 to the multi-flavor bar valve 14. For purposes of clarity, some of the product lines and gas lines have not been shown in FIG. 1. For example, for the five bottle gripping cylinders 22 shown in FIG. 1, there would be five product lines and five gas lines. Also, although in the exemplary embodiment the quick-disconnect fittings are straight or in-line configurations, right-angle or L-shaped configurations or any other suitable type of quick-disconnect fitting can be used alternatively. To inhibit leakage of product during connecting and disconnecting , the quick-disconnect fittings can be of the double shut-off type. Suitable quick-disconnect fittings are well known in the art, commercially available from a variety of sources, and therefore not described in further detail herein.

Also included inside the dispenser is a gas system comprising a CO₂ bottle and regulator combination 34, and a manifold 36. The purpose of the gas system is to pressurize the bottles 24 so product is forced out through the product lines 32 to the bar valve 14 when the bar valve 14 is opened. The CO₂ bottle can be either a refillable type or a disposable type. The regulator, which can be of the conventional type commonly used for beverage dispensing, can be permanently attached directly to the manifold 36 or in any other suitable manner. The gas system is preferably attached to the inside wall of the ice chest 10 and is easily removable for cleaning and changing cylinders. In some embodiments, the bottle retaining cage 18 can include an extension (not shown) that supports the gas system. Although in the exemplary embodiment of the invention the pressurizing system or means for pressurizing the bottles 24 comprises the above-described gas system or elements thereof, in other embodiments it can comprise a manual or electrically powered air pump.

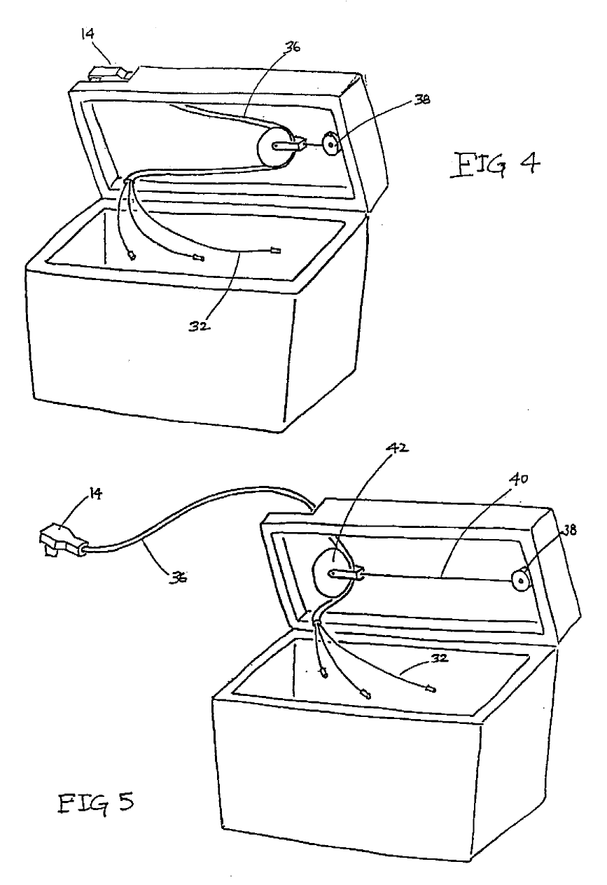

As shown in further detail in FIGS. 4-5 (shown with cover plate 16 removed from lid 12 for clarity) product lines 32 are connected to bar valve 14 and routed through a flexible protective tubing sheath 36. When the dispenser is not being used, sheath 36, as well as the product lines 32 inside it, are retracted inside the lid 12 by a spring-powered reel assembly comprising a reel 38, a cable 40 and a wheel subassembly 42. To dispense a drink the operator grabs the bar valve 14 and pulls it out of the lid 12. Reel 38 allows the bar valve 14 to be resiliently pulled away from the lid 12 with minimal resistance so that a drink can be dispensed into a cup (not shown). The end of sheath 36 that is farthest from the bar valve 14 is attached to the lid 12 so that the sheath 36 cannot be pulled too far out of the lid 12. When dispensing is completed, the user can release or ease tension on bar valve 14, and the reel 38 resiliently (i.e., under power of an internal spring) retracts sheath 36 and product lines 32 back into the lid 12 until another drink is to be dispensed. As sheath 36 extends and retracts it rolls around wheel subassembly 42. In embodiments without such a wheel subassembly or other retractor, a user could simply urge the lines and their sheath back into the ice chest through the opening. In such embodiments, a suitably rigid sheath can facilitate the lines and sheath retreating into the opening in this manner without additional effort, as the inherent result of the user returning the bar valve to the area where it is stored (over the opening). A U-shaped or other suitably shaped tube (not shown) can be included in such embodiments to facilitate guiding the lines and sheath. In any event, as premix beverages are prone to excessive foaming when being dispensed, and one way to reduce foaming is to keep the product as cold as possible, having sheath 36 retracted inside the cool interior of the ice chest 10 helps to insure that the beverage inside product lines 32 remains as cold as possible. The function of cover 16 is to prevent sheath 36 and wheel subassembly 42 from dropping down into the interior of the ice chest 10 when lid 12 is closed. Note, however, that cover 16 has holes 41 to allow cold air to circulate around product lines 32. Although not shown for purposes of clarity, ribs or other features formed in the underside of lid 12 or cover 16 can be included to aid in guiding the path of wheel assembly 42 as it moves back and forth.

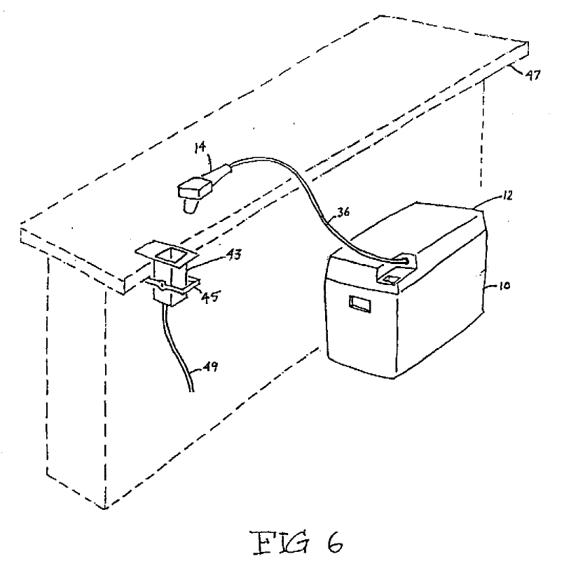

As there may be instances where it is desirable for sheath 36 and bar valve 14 to remain in the extended position and not be retracted automatically, lid cover 16 can include a catch (not shown) or engagement that holds sheath 36 in the extended position for as long as required. As shown in FIG. 6, a remote bar valve holder 43 can be used with the dispenser in such situations. The holder 43 can have a spring clamp 45 that allows it to be attached to the edge of a table or bar 47. A drain line 49 can be routed from the holder 43 to a suitable drain or to a container (not shown) inside the dispenser. Alternatively, the holder 43 can include a removable drip tray (not shown) to catch any drippings from the bar valve 14. In other embodiments of the invention, a similar bar valve holder can be incorporated into a telescoping handle (not shown) that is part of the ice chest. It should be noted that although in the exemplary embodiment sheath 36 resiliently retracts into the dispenser, in other embodiments the sheath can be attached to another part of the dispenser and stored in any other suitable manner.

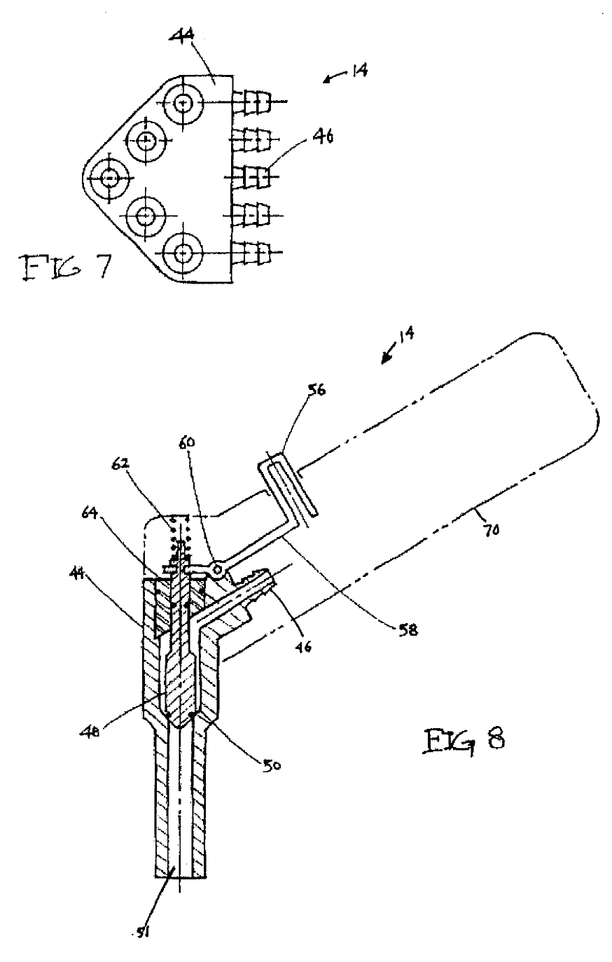

As shown in FIGS. 7-8, bar valve 14, which controls beverage dispensing, is connected to the distal ends of product lines 32 that are connected to cap assemblies 26. Bar valve 14 has a body 44 that is preferably made of molded plastic and includes barbed fittings 46 to which the product lines 32 are connected. Beverage is dispensed from the valve body and flows out a conduit 51 when the poppet 48 is lifted off of the poppet seat 50. Beverage flow stops when poppet 48 returns to seat 50. An o-ring creates the seal between poppet 48 and seat 50. The lifting and reseating of the poppet 48 is controlled by a button/lever assembly that is made up of a button 56 and a lever 58. The lever pivots on a pivot 60, which is attached to the valve body 44. When an operator pushes down on button 56, lever 58 pivots on pivot 60 to cause the poppet 48 to lift off the seat and dispense the (beverage) product. When the button 56 is released, a spring 62 returns the poppet 48 to its seated position. Poppet 48 moves up and down in plug 64. Plug 64 is sealed to the valve body 44 with a static o-ring. The poppet 48 is sealed to plug 64 by a dynamic o-ring. The portion of poppet 48 that seals inside plug 64 is smaller than the portion of the poppet that seals against seat 50, thereby allowing the fluid pressure inside the valve body 44 to help hold the poppet 48 in the sealed position. Lever 58 is designed so that the leg from the pivot 60 to the poppet 48 is shorter than the leg from the pivot 60 to the button 56. This creates a mechanical advantage that makes it easy to open the valve, even when there is a high fluid pressure within the valve. A cover/handle 70 encapsulates components of the valve assembly and serves as an anchor to which sheath 36 (not shown in FIGS. 7-8) is attached. Although not shown for purposes of clarity, an adjustment screw, aligned coaxially with poppet 48, can be included in cover/handle 70 to allow the operator to limit the travel of the poppet 48 and thereby help to reduce foaming of the dispensed beverage.

Although the above-described dispenser can be manufactured in any suitable manner, in some embodiments of the invention a conventional ice chest can be retrofitted or modified to include a bar valve, gas system, product and gas lines, retaining cage, reel assembly, cap assemblies, etc., along the lines of those described above. Such a retrofitting or modifying method can include drilling or otherwise forming an opening (not shown) in the lid, inserting the gas system, product and gas lines, retaining cage, etc., and connecting the product line(s) with the bar valve through the opening. It should also be recognized that in some embodiments of the invention the dispenser can be provided in whole or in part in kit form. For example, a manufacturer can provide some or all of the above-described valve, gas system, lines, retaining cage, reel assembly, cap assemblies, etc., for an end-user to install in the ice chest and connect together in the way described above. In such embodiments, the ice chest itself can be included in the kit or provided separately.

It is to be understood that the present invention is not limited to the specific devices, methods, conditions, or parameters described and/or shown herein, and that the terminology used herein is for the purpose of describing particular embodiments of the invention by way of example only. For example, unless the context clearly dictates otherwise, as used in the specification and the appended claims, a reference to an element using the singular article “a,” “an,” or “the” encompasses both embodiments having no more than one and embodiments having more than one. The term “or” means “either or both.” Likewise, a reference to an element “on” another element also encompasses embodiments in which one is “in” the other, and conversely, a reference to an element “in” another element also encompasses embodiments in which one is “on” the other. “Coupled” means connected via zero or more intermediate elements. Also, a reference to a particular numerical value includes at least that particular value. In addition, any methods or processes set forth herein are not intended to be limited to the sequence of steps set forth but also encompass other sequences, unless expressly stated otherwise.

It will be apparent to those skilled in the art that various modifications and variations can be made to this invention without departing from the spirit or scope of the invention. Thus, it is intended that the present invention cover all modifications and variations of this invention that come within the scope of one or more claims and their equivalents. With regard to the claims, no claim is intended to invoke the sixth paragraph of 35 U.S.C. Section 112 unless it includes the term “means for” followed by a participle.

What is claimed is:

1. A beverage dispenser, comprising:
an insulated portable ice chest;
a pressurization system having a portion disposed inside the ice chest coupleable to at least one beverage container inside the ice chest;
a line system comprising a plurality of beverage lines, a first end of each beverage line of the plurality coupleable to a beverage container in the ice chest; and
a manually operable dispensing valve device disposed outside the ice chest and coupleable to a second end of each beverage line of the plurality, the dispensing valve device comprising a multi-product valve assembly having a plurality of manually operable buttons and a corresponding plurality of valves, each button coupled to a corresponding valve to dispense a corresponding beverage.

2. The beverage dispenser claimed in claim 1, further comprising a retractor coupled to the dispensing valve device to apply a retracting force to the dispensing valve device.

3. The beverage dispenser claimed in claim 2, wherein the retractor comprises a spring-loaded reel for winding a portion of the line system thereupon.

4. The beverage dispenser claimed in claim 1, wherein the ice chest has a lid with a recess for holding the dispensing valve device when not in use.

5. The beverage dispenser claimed in claim 1, wherein the pressurization system comprises a gas cylinder system.

6. The beverage dispenser claimed in claim 1, wherein the line system comprises a cap assembly having a gas fitting and a product fitting, wherein the cap assembly is threadably mateable with a standard 2-liter soft drink bottle.

7. The beverage dispenser claimed in claim 6, wherein the gas fitting and product fitting each comprises a quick-disconnect fitting.

8. A beverage dispenser, comprising:
an insulated portable ice chest;
a pressurization system having a portion disposed inside the ice chest coupleable to at least one beverage container inside the ice chest;
a line system comprising at least one beverage line, a first end of the beverage line coupleable to a beverage container in the ice chest;
a dispensing valve device disposed outside the ice chest and coupleable to a second end of the beverage line for dispensing at least one beverage from the beverage container through the dispensing valve device; and
a retractor coupled to the dispensing valve device to apply a retracting force to the dispensing valve device, wherein in a retracted position the dispensing valve device is received in a holder on the ice chest.

9. The beverage dispenser claimed in claim 8, wherein:
the dispensing valve device comprises a multi-product valve assembly having a plurality of manually operable buttons and a corresponding plurality of valves, each button coupled to a corresponding valve to dispense a corresponding beverage; and
the line system comprises a plurality of beverage lines, each coupled to one of the plurality of valves.

10. The beverage dispenser claimed in claim 8, wherein the line system comprises a cap assembly having a gas fitting and a product fitting, wherein the cap assembly is threadably mateable with a standard 2-liter soft drink bottle.

11. The beverage dispenser claimed in claim 10, wherein the gas fitting and product fitting each comprises a quick-disconnect fitting.

12. A method for dispensing a beverage from a dispenser comprising an insulated portable ice chest, the method comprising:
extending a dispensing valve device away from the ice chest against a force exerted by a retractor;
actuating the dispensing valve device to cause a beverage to flow from a container in the ice chest through a beverage line and out of the dispensing valve device; and
causing the retractor to retract the dispensing valve device toward the ice chest.

13. The method claimed in claim 12, wherein:
the step of extending a dispensing valve device away from the ice chest comprises removing the dispensing valve device from a holder on the ice chest; and
the step of retracting the dispensing valve device toward the ice chest comprises placing the dispensing valve device in the holder.
